(19) United States
(12) Patent Application Publication
(10) Pub. No.: US 2026/0148590 A1
(43) Pub. Date: May 28, 2026

(54) Parking Machine For A Parking System

(71) Applicants: Bernd Möller, Mönchengladbach (DE); Daniel Böhmer, Mülheim (DE)

(72) Inventors: Bernd Möller, Mönchengladbach (DE); Daniel Böhmer, Mülheim (DE)

(73) Assignee: Scheidt & Bachmann GmbH, Mönchengladbach (DE)

(21) Appl. No.: 19/394,148

(22) Filed: Nov. 19, 2025

(30) Foreign Application Priority Data
Nov. 22, 2024 (DE) 10 2024 134 382.6

(51) Int. Cl. G07B 15/02; G06Q 20/32

(52) U.S. Cl. CPC G07B 15/02; G06Q 20/3276

(57) ABSTRACT

A parking machine for a parking system includes a user interface configured to receive a parking payment request from a user. It includes a parking data set with a parking transaction identifier. It includes a sequence control module configured to control a payment transaction at the parking machine based on the received parking payment request. The payment process includes at least a transmitting of the parking data set to a data processing device connected remotely to the parking machine by means of a first communication connection.

### CROSS-REFERENCE TO RELATED PATENT APPLICATION

This patent application claims the benefit of priority to German Patent Application No. 10 2024 134 382.6, filed Nov. 22, 2024, the entire teachings and disclosures are incorporated herein by reference thereto.

### FIELD OF THE INVENTION

The invention relates to a parking machine for a parking system comprising at least one user interface configured to receive a parking payment request (from a user), containing a parking data set with at least one parking transaction identifier, at least one sequence control module configured to control a payment transaction (at the parking machine) based on the received parking payment request, wherein the payment process comprises at least a transmitting of the parking data set to a data processing device connected remotely to the parking machine by means of a first communication connection. Furthermore, the invention relates to a parking system, a method, and a computer program.

### BACKGROUND OF THE INVENTION

Parking systems with at least one parking device are known from the prior art. A parking device is, in particular, a parking garage or a parking lot for vehicles and cars, respectively. Such parking systems are also referred to as off-street parking systems respectively off-street parking facilities.

Such a parking system usually comprises one or more vehicle access devices at a respective number of passageways to and/or from a parking device. For example, a vehicle access device with a blocking means, such as a barrier with a swiveling barrier arm may be provided. Such a vehicle access device is used, in particular, to control respectively regulate the driving through of a vehicle from a first area into a further area through a passageway at which the vehicle access device is arranged.

In a parking system, for example, at least one vehicle access device can be provided to control the driving through of a vehicle from an uncontrolled area, for example, a (public) road, into a controlled area, for example, the parking area respectively the parking device. In other words, a driving into the parking device can be controlled by a vehicle access device at an entry of the parking system. Alternatively or additionally, at least one vehicle access device may be provided in a parking system to control the driving out of a vehicle from the controlled area into the uncontrolled area. In other words, the driving out of a vehicle from the parking device at an exit may be controlled by a vehicle access device.

A vehicle access device with a blocking element, but also a vehicle access device without a blocking element (also referred to as a free-flow system or free-flow vehicle access device) may be arranged at an entry and/or exit. Entries and/or exits can be structurally separate, for example, with separate lanes for entry and exit and separate vehicle access devices, or combined, for example, with an entry and exit with a shared lane and a shared vehicle access device. Furthermore, at the entry and/or exit, several lanes may be located next to each other in one direction, in particular, with and without structural separation of the lanes.

In the case of known vehicle access devices, driving into a parking device is granted after a parking ticket, such as a short-term parking ticket, has been issued by a ticket dispenser module based on user action at the ticket dispenser module. The short-term parking ticket, in particular, a paper ticket, can then be paid for by a user at a parking machine at the end of a parking period respectively parking duration and checked at the exit by a validation device respectively a validator of the vehicle access device. If the check is positive, a driving through the passageway (in this case the exit) is released. However, if the validation device determines that the ticket has not yet been paid for, for example, or that the payment is overdue, the vehicle access device remains closed and the passageway is blocked. In other words, driving through the passageway is blocked by a release module.

Alternatively or in addition to receiving a parking ticket when driving into the parking device, the license plate number of the vehicle driving in can be detected and identified. For this purpose, a (respective) license plate recognition equipment comprising at least one camera can be provided at a passageway (in particular, at each passageway). The at least one camera of a license plate recognition equipment is configured to detect image data of a vehicle license plate of a vehicle passing through respectively driving through the corresponding passageway. This includes, in particular, the detecting of the aforementioned image data before driving through the passageway.

The license plate recognition equipment may comprise the camera and an image evaluation module connected to the camera. The image evaluation module may be configured to determine the vehicle license plate from the detected image data. Such a license plate recognition equipment (with camera and image evaluation module) is also referred to as an LPR (License Plate Recognition) license plate recognition equipment. In an LPR license plate recognition equipment, the image of the vehicle license plate detected by the camera is evaluated by the image evaluation module, in particular, by means of OCR (Optical Character Recognition), in order to determine the vehicle license plate number.

In particular, in addition to the image data, the respective license plate recognition equipment can also determine the time point of driving through (in particular, an entry time point or an exit time point). A (remotely located) data processing device of the parking system can be configured to evaluate the aforementioned data. For example, the data processing device can be configured to determine the parking duration from the difference between the entry time point and exit time point for the same vehicle license plate number respectively the same vehicle. In addition, access authorizations (e.g., long-term parking permits) can be linked to a vehicle license plate number, for example, in a data memory of a data processing device.

If the data processing device also determines that a short-term parker has paid the parking fee, in particular, at a parking machine, before driving out, the vehicle license plate number can be used to identify the parking process to be paid for during the payment process.

If a parking ticket is used for the parking process, a readable parking transaction identifier, in particular, in the form of a parking ticket identifier, may be stored on the parking ticket. The entry time point (respectively the time point of dispensing of the parking ticket) and the parking transaction identifier of the dispensed parking ticket may be stored together in the data processing device of the parking system. If the vehicle license plate number is detected and determined as the parking transaction identifier for the parking process, the vehicle license plate number can be stored together with the time of detecting of the vehicle license plate number in a data processing device of the parking system.

In order to pay for a parking process, a parking payment request containing a parking data set with at least one parking transaction identifier can be received at a parking machine (also referred to as a payment terminal or pay station) of the parking system by means of a user interface of the parking machine.

If the parking transaction identifier is stored on a parking ticket, for example, the user interface can be configured to read the parking transaction identifier of a parking ticket of the user. By means of a first communication connection, the parking machine can exchange data with the data processing device located remotely from the parking machine and, in particular, use the received parking transaction identifier to retrieve the corresponding entry time point and/or the parking fee already calculated by the data processing device.

The user can pay the parking fee for the parking process using a payment module at the parking machine and then drive out of the parking device with their vehicle at an exit. For this purpose, the parking transaction identifier can be marked as authorized for exit in the data processing device and, in particular, stored. As has been described, a validation device may be arranged at an exit, which may be communicatively connected to the data processing device. A parking transaction identifier read by the validation device can be checked by the validation device by means of the communicatively connected data processing device. If the parking transaction identifier is marked as authorized to drive out, a driving out can be released by an vehicle access device, as has been described.

If the parking transaction identifier is, for example, a vehicle license plate number, the payment transaction can be carried out in a similar way at the parking machine: The user can enter a parking payment request at a parking machine by means of a user interface, containing a parking data set with at least one parking transaction identifier in the form of his/her vehicle license plate number. In other words, the user interface receives at least the parking transaction identifier.

Then, using the vehicle license plate number detected at an entry and stored in the data processing device, the parking duration and the parking fee for the parking process can be calculated in the manner described above using the corresponding entry time point. The vehicle license plate number can then be stored in the data processing device as authorized to drive out. At the exit of the parking device, the vehicle license plate number can be detected and identified by a license plate recognition equipment. If it is determined that the vehicle license plate number stored in the data processing device is marked as authorized to drive out, a driving out of the vehicle can be released.

In addition, hybrid systems are in use in the prior art, in which a ticket is dispensed at the entry and the vehicle license plate is detected and identified. The parking ticket is then read at a parking machine in the parking system and the payment process is handled as has been described above. At the exit, the vehicle license plate number can then be recognized and the vehicle access device can be released, in particular, without the parking ticket having to be scanned again. If there are problems with the license plate recognition, the parking ticket can be used as a fallback option.

A disadvantage of the described parking systems is that for an execution error of the payment machine during the payment process, for example, due to a communication interruption between the parking machine and the data processing device, it is not possible to execute the payment process. A user must then either switch to another parking machine—if one is available at all—or seek manual assistance from the staff of the parking system provider. This significantly reduces user convenience, as it delays and complicates the process of driving out of the parking space. For the parking system provider, the cost of providing additional parking machines and/or staff is increased.

### SUMMARY OF THE INVENTION

Therefore, it is the object of the invention to provide a possibility for parking systems with which the disadvantages of the prior art can at least be reduced and, in particular, user convenience in the parking system can be improved and the number of parking machines required for the parking system can be reduced.

The object is solved according to a first aspect of the invention by a parking machine according to claim 1 for a parking system, in particular, for a parking system according to claim 10. The parking machine comprises at least one user interface. The user interface is configured to receive a parking payment request. The parking payment request contains a parking data set with at least one parking transaction identifier. The parking payment machine comprises at least one sequence control module. The sequence control module is configured to control, in particular, coordinate, a payment transaction (at the parking payment machine) based on the received parking payment request. The payment process comprises at least a transmitting of the parking data set to a data processing device connected remotely to the parking machine by means of a first communication connection. The parking machine comprises at least one detection module. The detection module is configured to detect an execution error of the parking machine during executing the parking payment request. The parking machine comprises at least one generation module. The generation module is configured to at least cause an outputting of a communication data set readable by a mobile terminal (only) if an execution error of the parking machine is detected during the executing of the parking payment request. The readable communication data set contains at least one instruction datum for the mobile terminal for executing the payment process with the data processing device and/or a computing device connectable to the data processing device independently of the parking machine.

A further aspect of the invention is a parking system according to claim 10. The parking system comprises at least one parking machine as described above (according to claim 1). The parking system comprises a data processing device connected to the parking machine by means of a first communication connection and/or at least one computing device connectable to the data processing device.

In contrast to the prior art, according to the invention, a parking machine is provided for a parking system with which the disadvantages of the prior art can be reduced at least to an extent that is significant and, in particular, user comfort in the parking system is improved and the number of parking machines required for the parking system (respectively the number of necessary ones) by the parking machine being configured to detect that a parking payment transaction at the parking payment machine is (currently) not possible due to an execution error of the parking payment machine, and to subsequently refer to an alternative option for executing the parking payment transaction independently of the parking payment machine. In particular, a user with a mobile terminal at the parking machine is given the option of paying for his/her parking independently of the (defective) parking machine by using his/her mobile terminal instead of the parking machine by means of the communication data set provided to and readable by the mobile terminal.

The parking system according to the invention is, in particular, an off-street parking system. The parking system is used, in particular, for the (temporary) parking of vehicles (in particular, passenger cars and automobiles, respectively) in a parking device. The parking of a vehicle in the parking device is referred to, in particular, as a parking process. Preferably, the parking system comprises the parking device. The parking device is, in particular, a parking lot with a plurality of parking spaces and/or a parking garage with a plurality of parking spaces.

A vehicle can drive into the parking device via an entry of the parking system, in particular, the parking device, with an entry area. A vehicle can drive out of the parking device via an exit of the parking system, in particular, the parking device, with an exit area.

The entry and/or exit may be structurally separate, for example, with separate lanes for entry and exit and separate vehicle access devices, or they may be combined, for example with an entry and exit with a shared lane and a shared vehicle access device. Furthermore, in the case of entry and/or exit, several lanes may be located next to each other in one direction, in particular, with and without structural separation of the lanes.

According to one embodiment, the parking system may comprise at least one vehicle access device arranged at an entry, for example, with at least one parking ticket dispensing module. The parking ticket dispensing module can be configured to dispense a parking ticket, in particular, in response to detecting a user action, like pressing an input means of the parking ticket dispensing module or the like.

The parking ticket (e.g., a paper ticket) may comprise a parking transaction identifier, in particular, in the form of a parking ticket identifier. A parking transaction identifier uniquely identifies (across the entire parking system) a parking transaction involving a vehicle. An entry data set can be transmitted to the data processing device by means of a (wireless and/or wired) communication connection between the access control device and a (remote) (central) data processing device. The entry data set can contain at least the parking transaction identifier and, in particular, an entry time point (for example, the time point when the parking ticket was dispensed).

Alternatively or additionally, the parking system may comprise at least one license plate recognition equipment. Preferably, a respective license plate recognition equipment may be an LPR equipment. A license plate recognition equipment comprises, in particular, one or more cameras. In a first license plate recognition equipment, the at least one camera may be arranged in or at the entry. In a second license plate recognition equipment, the at least one camera may be arranged in or at the exit. The respective camera may be positioned in such a way that image data from the license plates of the respective vehicles passing through can be detected, i.e., in such a way that the respective vehicles must pass through the respective detection field of the respective camera.

A license plate recognition equipment may comprise at least one image evaluation module. For example, each license plate recognition equipment may have a respective image evaluation module, or two or more license plate recognition equipment pieces may share a common image evaluation module. For example, the data processing device may comprise the at least one image evaluation module.

A first license plate recognition equipment can transmit an entry data set to a storage module of the data processing device by means of a (wireless and/or wired) communication connection after detecting and identifying a vehicle license plate of a vehicle driving in. For example, the image evaluation module can be integrated in the camera at the entry, and the entry data set, containing at least a parking transaction identifier in the form of the determined vehicle license plate and the entry time point (in particular, the aforementioned detection time point), can be transmitted from the camera to the data processing device via a communication connection. The entry data set can be stored in a memory module of the data processing device.

In variants of the invention, the image evaluation module may be integrated in the data processing device and provide the entry data set to the storage module. The data transmitted to the data processing device via the communication connection may contain the detected image data and, for example, the detection time. From this data, the entry data set of the vehicle driving in can be generated, containing at least the parking transaction identifier in the form of the determined vehicle license plate number and the entry time point (in particular, the detection time point).

The parking system preferably comprises the (central) data processing device. The (central) data processing device can be formed by one or more computers and can comprise at least one processor. The at least one processor (together with memory means and the like) can be configured to execute and/or control software modules (e.g., communication module, parking duration determination module, payment module, etc.).

For example, the data processing device can be formed by at least one local computer arranged at the parking device of the parking system, but preferably by at least one background system arranged remotely from the parking device. The background system can preferably be formed by one or more (distributed) computers (e.g., servers) and/or a cloud system.

In particular, in addition to the data processing device, the parking system may comprise a computing device (arranged remotely from the parking machine) that is communicatively connected to the data processing device in one embodiment of the parking system. The computing device may comprise at least one processor. The at least one processor (together with memory means and the like) may be configured to execute and/or control software modules (e.g., third communication module, payment module, etc.).

The parking system comprises at least one (stationary respectively immovably installed) parking machine. A parking machine is intended for use in a parking system and is, in particular, arranged adjacent to a parking device. A parking machine is, in particular, configured to execute a payment transaction for a parking process performed in the parking system on the basis of the parking transaction identifier (uniquely) assigned to this parking process.

The parking machine comprises at least one user interface. Examples of user interfaces include, but are not limited to a parking ticket reading module (configured to detect respectively read at least the parking transaction identifier of the parking ticket), a touch display (configured to detect at least one user input of a parking transaction identifier), a keyboard (configured to detect at least one user input of a parking transaction identifier), etc. It shall be understood that, in variants of the invention, two or more (different) user interfaces may be provided at the parking machine.

The at least one user interface is configured to receive a parking payment request. In particular, the user interface can detect a parking payment request, for example, by detecting a detected parking transaction identifier and/or by a user input of a parking transaction identifier. A parking payment request contains a parking data set that contains at least the parking transaction identifier. A parking payment request contains at least implicitly a request to pay for the parking transaction associated with the received parking transaction identifier.

In addition, the parking machine comprises at least one sequence control module (in particular, executable by a processor of the parking machine). The sequence control module is configured to control a payment process. This means, in particular, that the sequence control module controls respectively coordinates the execution of the sub-steps of the payment process by the parking machine. The payment process is controlled, in particular, in (immediate) response to a received parking payment request. The controlling of the payment process comprises at least a transmitting of the received parking data set, in particular, by a communication module of the parking machine, to the data processing device connected remotely to the parking machine by means of a first (wireless and/or wired) communication connection. The communication module can be controlled accordingly by the sequence control module. In addition to the parking transaction identifier, the transmitted parking data set may contain at least one exit time respectively a parking end time point (in particular, the time point of receipt of the parking data set by the first user interface). Alternatively, the parking end time point may be, for example, the time point of receipt of the parking data set by the data processing device).

The communication module of the parking machine can be configured to receive, in response to a transmitted parking data set, an indication of the parking fee to be paid for the parking process. Alternatively, the parking machine can receive the corresponding entry time point from the data processing device in response to a transmitted parking data set and, in particular, determine the parking fee from this.

The sequence control module can be configured to control a displaying of the received respectively determined parking fee, for example, by means of an optical display at the parking machine. Furthermore, the sequence control module can control the payment process for the parking fee, for example, a payment module (e.g., card reader, cash payment module, etc.) of the parking machine.

After a detection of (full) payment of the parking fee by the sequence control module, the sequence control module can control the communication module of the parking machine in such a way that the parking transaction identifier associated with this parking transaction is reported to the data processing device as authorized for driving out. The data processing device (in particular, the storage module) can mark and store the parking transaction identifier accordingly. In particular, as described above, a driving out from the parking device can be released for this parking transaction identifier.

According to the invention, the parking machine comprises at least one detection module. The detection module is configured to detect an execution error of the parking machine during executing the parking payment request. An execution error of the parking machine during executing the parking payment request means, in particular, that a payment for a parking process at the parking machine is not possible (at that moment). In particular, the detection module can be configured to monitor the respective functional state of (all) modules/components of the parking machine that may be involved in a payment process. In particular, the detection module can evaluate the respective functional state and determine whether a payment for a parking process at the parking machine is (currently) possible or not.

In addition, the parking machine according to the invention comprises a generation module. The generation module is configured at least to cause an outputting of a communication data set readable by a mobile terminal if, and in particular only if, an execution error of the parking machine is detected (by the detection module) during executing of the parking payment request. A causing of outputting the readable communication data set means, in particular, that the communication data set is (technically) provided at the parking machine in such a way that it is readable respectively receivable by a mobile terminal at the parking machine.

The readable and, in particular, provided communication data set contains at least one instruction datum for the mobile terminal. When executed by a processor of the mobile terminal, the instruction datum causes at least an initialization of a payment process (for the parking process) with the data processing device and/or a computing device communicatively connectable to the data processing device independently from the parking machine. In particular, upon a receipt of the at least one instruction datum, this instruction datum can be executed (automatically or after a user confirmation) by the processor of the mobile terminal so that the user receives an alternative payment method for his/her parking transaction by means of his/her mobile terminal in the event of an execution error at the parking machine. This enables a paying for the parking transaction in a user-friendly and low-effort manner, even if the parking machine is defective.

According to a preferred embodiment of the parking machine according to the invention, the generation module can be configured to generate (as a communication data set) a graphical code containing the at least one instruction datum. The at least one graphical code can, in particular, be a barcode and/or a QR code. As (encoded) data content, the graphical code can, in particular, contain the at least one instruction datum.

Preferably, the generation module can be configured to cause an outputting of the communication data set by causing a displaying of the graphical code on an optical display of the parking machine. The parking machine can, in particular, comprise at least one optical display. For example, the optical display can be a touch display, which can also be used as the user interface described above. The graphical code displayed on the optical display can be detected by a mobile terminal, in particular, by an optical sensor, such as a camera, of the mobile terminal. Furthermore, the data content of the graphical code can be extracted and processed, in particular, by a processor of the mobile terminal. The at least one instruction datum can be transmitted in a simple manner.

The generation module can preferably also be configured to cause a displaying of a prompt respectively a user message on the optical display of the parking machine for detecting the graphical code. In particular, both the graphical code and the prompt can be displayed on the optical display of the parking machine, caused by the generation module. For example, a message (e.g., “The parking machine is out of order. Please scan the displayed code to complete the payment process”) can be displayed on the optical display as a prompt.

Alternatively or additionally, according to a further embodiment of the parking machine according to the invention, the generation module can be configured to generate (as a communication data set) a transmission code containing the at least one instruction datum, wherein the transmission code is transmittable by means of a near-field interface of the parking machine. The at least one near-field interface may have a range of between 0 and 15 m, for example, between 0 and approx. 5 m. Preferred and non-exclusive near-field interfaces are a Bluetooth interface and an NFC interface. This enables a (particularly simple) detecting of the instruction datum by the mobile terminal at the parking machine.

In particular, the signal transmitted by a Bluetooth interface, wherein the signal contains as data content at least one transmission code with the at least one instruction datum, can be an advertising signal. An advertising signal is, in particular, a signal that can be received and evaluated by almost all commercially available mobile terminals.

The generation module can preferably be configured to cause an outputting of the communication data set by causing an (at least almost continuously) transmitting and/or providing of the transmission code by means of the near field interface. In particular, a transmitted signal containing the transmission code can be received by a mobile terminal. In the case of an NFC interface, it may be necessary to bring the mobile terminal close to the NFC interface in order to receive the transmission code. It shall be understood that two or more near-field interfaces may be provided.

According to a particularly preferred embodiment of the parking machine according to the invention, the generation module can be configured to generate a dynamic graphical code and/or a dynamic transmission code. In other words, a code with varying data content can be generated. The data content of the code may, for example, be valid for a limited period of time and, after expiry of the (settable) time, be replaced by a subsequent code with further, modified data content. This can, in particular, improve tamper resistance, for example, against misuse of photographed graphical codes.

According to a further preferred embodiment of the parking machine according to the invention, the detection module can be configured to monitor the first communication connection. In particular, the detection module can be configured to monitor the functional state of the first communication connection. This means, in particular, that the detection module can detect whether the first communication connection is functional or not, i.e., whether there is a communication interruption. Preferably, the detection module can be configured to detect an execution error of the parking machine as soon as a communication interruption with the data processing device is detected by monitoring the first communication connection. In particular, in the event of a communication interruption, a parking data set (already) cannot be transmitted by the parking machine to the data processing device by means of the first communication connection. Accordingly, a payment transaction for a parking transaction cannot be carried out at the parking machine itself (during the communication interruption) (since at least the associated entry time point is not known to the parking machine). By monitoring the state of the first communication connection and providing an alternative payment option by means of a communication data set output upon a detection of a communication interruption, the user can independently initiate the calculation of parking fees for a parking process and carry out a payment process even in the event of a communication interruption between the parking machine and the data processing device.

According to a preferred embodiment of the parking machine according to the invention, the detection module can be configured to monitor the first communication connection by monitoring the data log data and/or operating data received by the parking machine from the data processing device by means of the first communication connection. In particular, it has been found that data log data and/or operating data are exchanged regularly and/or at specific times via the first communication connection between parking machines and the data processing device. In particular, the first communication connection may be a TCP/IP network connection. In such a communication connection, data log data and/or operating data are exchanged between two connected communication modules regularly and/or at specific times.

Preferably, the detection module can be configured to detect a communication interruption if no reception of data log data and/or operating data is detected at the communication module of the parking machine for a predefined period of time (e.g., between 1 s and 60 s).

According to a further preferred embodiment of the parking machine according to the invention, the detection module can be configured to monitor at least one payment module of the parking machine involved in the payment process. A payment module involved in the payment process means a hardware module and/or software module of the parking machine that is (mandatorily) required for performing a payment process at the parking machine.

The detection module can preferably be configured to detect an execution error of the parking machine if by the monitoring of the at least one payment module it is determined that the payment process at the parking machine cannot be executed.

According to a further embodiment of the parking machine according to the invention, the at least one payment module may be a cash payment module. The detection module may be configured to monitor the state of the cash payment module. For example, the coin and/or banknote cash box of the cash payment module may be monitored by the detection module. If, for example, the detection module detects that the coin and/or banknote cash register is full, an execution error can be detected. An execution error can also be detected by the detection module if there is no more change in the coin and/or banknote cash register.

Alternatively or additionally, the at least one payment module can be a card reader. The detection module can be configured to monitor the state of the card reader. In particular, the detection module can determine whether the card reader is defective or not. In the event of a defective state, an execution error of the parking machine can be detected.

According to a further embodiment of the parking machine according to the invention, the detection module can be configured to monitor at least one user interface of the parking machine. The detection module can be configured to detect an execution error of the parking machine if by the monitoring of the at least one user interface it is determined that a payment process cannot be executed at the parking machine.

According to a further embodiment of the parking machine according to the invention, the at least one user interface may be a parking ticket reader. The detection module may be configured to monitor the state of the parking ticket reader. Alternatively or additionally, the at least one user interface may be a touch display. The detection module may be configured to monitor the state of the touch display. Alternatively or additionally, the at least one user interface may be a keyboard. The detection module may be configured to monitor the state of the keyboard.

In one variant of the invention, it may be necessary for the generation module to only cause an outputting of a communication data set if a payment transaction cannot be carried out in any way at the payment machine. For example, a parking machine may comprise two payment modules, which can be used alternatively to each other to carry out a payment transaction at the parking machine, such as a card reader and a cash payment module. According to one embodiment, the generation module can be configured to at least cause an outputting of a communication data set readable by a mobile terminal (only) if an execution error of the parking machine is detected during execution of the parking payment request, which prevents any execution of the payment process at the parking machine. For example, if the parking machine has exactly one card reader and exactly one cash payment module, both the card reader and the cash payment module must be in a state that does not allow the respective module to operate.

In further variants of the invention, the generation module can be configured to at least cause an outputting of a communication data set readable by a mobile terminal device if an execution error of the parking machine is detected during execution of the parking payment request, which prevents an alternative payment process from being carried out at the parking machine. In the above example, payment with a card-based payment method may not be possible due to a malfunction of the card reader, but the cash payment module may still be functional. Nevertheless, in this variant, the communication data set can be provided to the user.

Further examples of payment modules of the parking machine that can be monitored by the detection module include at least one sequence control module and at least one user interface. For example, at least one user interface may have a malfunction, such as a defective parking ticket reader, a defective touch display, or a defective keyboard.

According to a particularly preferred embodiment of the parking machine according to the invention, the communication data set can comprise as an instruction datum at least one network address of the data processing device and/or one network address of the computing device such that a data connection is establishable between the mobile terminal and the data processing device and/or the computing device by means of a second communication connection. The second communication connection may differ from the first communication connection.

Preferably, the network address can be a web address. For example, in the case of a barcode or QR code, this can contain a web address (URL) as data content. The mobile terminal can extract the data content and, for example, after a user confirmation, call up the determined web address of the data processing device or the computing device connectable to the data processing device by means of a web browser of the mobile terminal started on the basis of the instruction datum executed by the processor. As will be described below, the accessed website or the corresponding device may offer an alternative payment method. By using a different communication connection (e.g., a mobile radio connection) between the mobile terminal and the data processing device or the computing device than between the parking machine and the data processing device, the user can still carry out a payment transaction even if the first communication connection is interrupted.

According to a preferred embodiment of the parking system according to the invention, the data processing device may comprise at least one storage module configured to receive an entry data set containing at least one parking transaction identifier and an entry time point of a vehicle, in particular, as has already been described. For example, the data processing device may comprise a first communication module (controllable by a processor of the data processing device). The first communication module may be configured to receive an entry data set containing at least one parking transaction identifier (e.g., a parking ticket identifier) and an entry time point of a vehicle, in particular, as has already been described. The communication module can provide the entry data set to the storage module. In other variants of the invention, the image evaluation module can, for example, provide the entry data set to the storage module.

The at least one storage module can be configured to store the received entry data set in a database of the parking system, in particular, of the data processing device. In particular, all received entry data sets can be stored in the database.

The at least one first communication module may be configured to receive the parking data set, in particular, as has already been described. The first communication module is configured, in particular, for communication by means of the first communication connection.

According to a further preferred embodiment of the parking system according to the invention, the data processing device may comprise at least one second communication module (controllable by a processor of the data processing device). The second communication module may be configured to receive a terminal device data set from a mobile terminal device containing at least one parking transaction identifier. The second communication module is configured, in particular, for communication by means of the second communication connection.

Alternatively or additionally, the computing device connectable to the data processing device may comprise at least one third communication module (controllable by a processor of the computing device). The third communication module can be configured to receive a terminal device data set from a mobile terminal device containing at least one parking transaction identifier. The third communication module is configured, in particular, for communication by means of the second communication connection.

According to a further preferred embodiment of the parking system according to the invention, the data processing device may comprise at least one parking duration determination module. The parking duration determination module may be configured to determine the parking duration of a parking process based on the parking end time point of a received terminal device data set and an entry time point of a stored entry data set, wherein the entry data set from the plurality of stored entry data sets can be assigned to the received terminal device data set on the basis of the respective parking transaction identifier. The parking end time point of a received terminal device data set can, in particular, be the time point of receipt of the terminal device data set by the data processing device (or the computing device). It shall be understood that this can also be the transmission time point of the terminal device data set.

In particular, for example by means of the parking duration determination module, when a terminal device data set is received, the entry data set containing the same parking transaction identifier as the received terminal device data set can be identified from the plurality of stored entry data sets. The parking duration can then be determined on the basis of the entry time point and the parking end time point. For example, the parking duration determination module can be configured to determine the parking duration from the difference between the entry time point and the parking end time point for the same parking transaction identifier (e.g., vehicle license plate number or parking ticket identifier) respectively the same vehicle.

Preferably, the parking duration determination module can also be configured to determine the parking duration of a parking process based on the parking end time point of a received parking data set and an entry time point of a stored entry data set, wherein the entry data set can be assigned to the received parking data set from the plurality of stored entry data sets on the basis of the respective parking transaction identifier, in particular in a manner analogous to the process described above upon receipt of a terminal device data set.

In variants of the invention, the computing device may comprise at least one parking duration determination module configured to determine the parking duration of a parking process based on the parking end time point of a received terminal device data set and an entry time point of a stored entry data set, wherein the entry data set can be assigned to the received terminal device data set from the plurality of stored entry data sets on the basis of the respective parking transaction identifier.

According to a further embodiment of the parking system according to the invention, the data processing device may comprise at least one parking fee determination module. The parking fee determination module can be configured to determine the parking fee for a parking process based on the determined parking duration of the parking process and at least one tariff datum. In variants of the invention, the computing device can comprise a parking fee determination module. A determined parking duration can be provided to the parking fee determination module.

The second (respectively third communication module) may be configured to transmit the determined parking fee to the mobile terminal. The first communication module may be configured to transmit the determined parking fee to the parking machine.

According to a further embodiment, the data processing device and/or the computing device may comprise a payment module configured to enable a paying of the determined parking fee by means of the mobile terminal. The payment module can, in particular, enable that a user can pay his/her parking fee cashlessly by entering a payment method, e.g., credit card, PayPal, or SEPA direct debit, using his/her mobile terminal.

According to a further embodiment of the parking system according to the invention, after a payment for the parking process has been detected (in the manner described above), the parking transaction identifier can be marked as authorized for exit, for example, by the storage module. For example, it may be specified that the vehicle assigned to the parking transaction identifier authorized for exit may leave the parking facility (in the manner described above) within a predefined period of time (e.g., between 10 and 15 minutes).

Furthermore, the parking system may comprise the at least one mobile terminal. The mobile terminal is, in particular, a network-enabled mobile terminal. Examples of mobile terminal devices include, but are not limited to, smartphones, tablet computers, mobile game consoles, laptops, netbooks, data glasses, smart watches, and similar wearables. Alternatively, a mobile terminal device may be a dedicated parking ticketing device designed exclusively for a parking application.

A further aspect of the invention is a method, in particular, a computer-implemented method, for operating a parking machine, in particular, a parking machine described above (according to claim 1) (in particular, in a parking system described above (according to claim 10)). The method comprises:
detecting, by at least one detection module of the parking machine, an execution error of the parking machine during an executing of parking payment requests, and
causing, by at least one generation module of the parking machine, an outputting of a communication data set readable by a mobile terminal if an execution error of the parking machine is detected during the executing of the parking payment request,
wherein the readable communication data set contains at least one instruction datum for the mobile terminal for executing a payment transaction with a data processing device and/or with a computing device connectable to the data processing device independently of the parking machine.

A further aspect of the invention is a computer program comprising commands which, when executed by at least one processor of a parking machine, cause the parking machine to execute and/or control the method described above (according to claim 15).

The computer program, in particular the instructions or program commands, can be stored in a computer program product, in particular a program memory. For example, a program memory is a non-volatile memory such as a flash memory, a magnetic memory, an EEPROM memory (electrically erasable programmable read-only memory) and/or an optical memory.

In addition, a parking machine may have a main memory, for example a volatile or non-volatile memory, in particular a random access memory (RAM), such as a static RAM (SRAM), a dynamic RAM (DRAM), a ferroelectric RAM (FeRAM) and/or a magnetic RAM (MRAM). The at least one processor of the parking machine can, for example, store intermediate results or similar in the main memory.

The modules described above (e.g., receiving module, generating module, detection module, etc.) are preferably at least partially software elements (e.g., executable code) and can be executed by a processor of the parking machine. It should also be noted that terms such as “first,” “second,” etc. do not indicate an order of priority, but are used in particular to distinguish between two elements (e.g., communication module, etc.).

The features of the parking machines, parking systems, methods, and computer programs can be freely combined with one another. In particular, features of the description and/or the dependent claims, even with complete or partial circumvention of features of the independent claims, may be independently inventive when standing alone or freely combined with one another.

### BRIEF DESCRIPTION OF THE DRAWINGS

There are now a variety of possibilities for designing and further developing the parking machine, the method, the computer program, and the parking system according to the invention. Reference is made in this regard to the patent claims subordinate to the independent patent claims on the one hand, and to the description of embodiments in conjunction with the drawing on the other. The drawing shows:

FIG. 1 shows a schematic view of an embodiment of a parking machine according to the invention,

FIG. 2 shows a schematic view of an embodiment of a parking system according to the invention with an embodiment of a parking machine according to the invention,

FIG. 3 shows a schematic view of a further embodiment of a parking system according to the invention with an embodiment of a parking machine according to the invention,

FIG. 4 shows a diagram of an embodiment of a method according to the invention,

FIG. 5ashows an exemplified display indication of an embodiment of a parking machine according to the invention,

FIG. 5bshows an exemplified display indication of a mobile terminal according to the invention,

FIG. 5c shows a further exemplified display indication of a mobile terminal according to the invention, and

FIG. 5dshows a further exemplified display indication of a mobile terminal according to the invention.

### DETAILED DESCRIPTION

Similar reference signs are used below for similar elements.

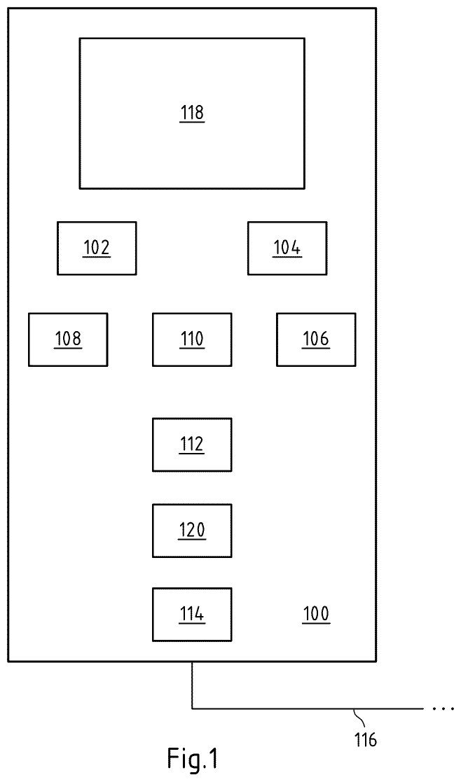

FIG. 1 shows an embodiment of a (stationary) parking machine 100 for a parking system. The parking machine 100 is, in particular, a component of the (not shown) parking system. The parking machine 100 is, in particular, configured to enable a performing of a payment transaction for a parking process performed in the parking system.

The parking machine 100 may comprise at least one processor 102 and a memory means 104 configured to execute and/or control software and/or hardware modules of the parking machine, such as modules 106 to 120.

The parking machine 100 comprises at least one user interface 108, 118 configured to receive a parking payment request containing a parking data set with at least one parking transaction identifier.

In the present embodiment, two user interfaces 108, 118 are provided by way of example. A first user interface 108 is, in particular, configured to read a parking ticket containing, for example, a (printed) parking code. The parking code (e.g., a barcode or QR code) preferably contains at least the parking transaction identifier (in particular, a parking ticket identifier) as data content. The parking transaction identifier is uniquely assigned to a parking process and has been generated, in particular, during a driving in of a vehicle.

In the present case, a further user interface 118 is an input device, in particular, in the form of a touch display. The further user interface 118 is, in particular, configured to receive a parking transaction identifier by detecting a parking transaction identifier manually entered by a user, in particular, in the form of a vehicle license plate number of the vehicle of the user.

In addition, the parking machine 100 comprises at least one sequence control module 106. The sequence control module 106 is configured to control a payment process based on the received parking payment request. This means, in particular, that the sequence control module 106 controls respectively coordinates the executing of the parking payment request respectively the payment process by the plurality of involved modules of the parking machine 100.

The payment process carried out at the parking machine 100 comprises at least a transmitting of the parking data set respectively the parking transaction identifier to a (not shown) data processing device (of the parking system) connected remotely to the parking machine 100 by means of a first communication connection 116. For transmitting the parking data set, the parking machine 100 may, in particular, comprise a communication module 114. The communication module 114 is configured for the first communication connection. In particular, the first communication connection 116 may be an Internet connection, in particular, a TCP/IP-based communication connection (and the communication module 114 may be configured accordingly).

According to the invention, the parking machine 100 comprises at least one detection module 110. The detection module 110 is configured to detect an execution error of the parking machine 100 during executing of the parking payment request. Preferably, the detection module 110 can be configured to monitor the functional state of the first communication connection (including the communication module 114) and/or the at least one user interface 108 118 and/or the sequence control module 106.

Monitoring the functional state of the first communication connection includes, in particular, detecting a communication interruption between the parking machine 100 and the data processing device. A communication interruption occurs, in particular, if no data can be exchanged (without errors) between the parking machine 100 and the data processing device.

In order to detect a communication interruption, the data traffic via the first communication connection 116 can be monitored, for example, at the communication module 114 of the parking machine 100. Preferably, the detection module 110 can monitor whether no reception (by the communication module 114 of the parking machine 100) of data log data and/or operating data is detected for a predefined period of time. If the detection module 110 determines that no reception (by the communication module 114 of the parking machine 100) of data log data and/or operating data is detected for a predefined period of time, the detection module 110 can determine respectively detect an execution error of the parking machine. As will be described below, the detection module 110 can monitor other payment modules involved in the payment process, such as the at least one user interface 108, 118 and/or the sequence control module 106.

The parking machine 100 comprises at least one generation module 112. The generation module 112 is configured at least to cause an outputting of a communication data set readable by a mobile terminal (not shown) as soon as an execution error of the parking machine 100 is detected during the executing of the parking payment request. In particular, a communication data set readable by the mobile terminal is only output if an execution error of the parking machine 100 is detected during the executing of the parking payment request.

The readable communication data set contains at least one instruction datum for the mobile terminal for executing the payment process with the data processing device and/or with a computing device connectable to the data processing device independently of the parking machine 100. Preferably, the generation module 112 can be configured to generate a graphical code containing the at least one instruction datum. In this case, the generation module 112 can be configured to cause an outputting of the communication data set by causing a displaying of the graphical code on an optional optical display 118 of the parking machine 100. Alternatively or additionally, the generation module 112 may be configured to generate a transmission code containing the at least one instruction datum transmittable by means of an optional near-field interface 120 of the parking machine 100. In this case, the generation module 112 may be configured to cause an outputting of the communication data set by causing a transmitting respectively providing of the transmission code by means of the near-field interface 120 (e.g., an NFC interface or a Bluetooth interface).

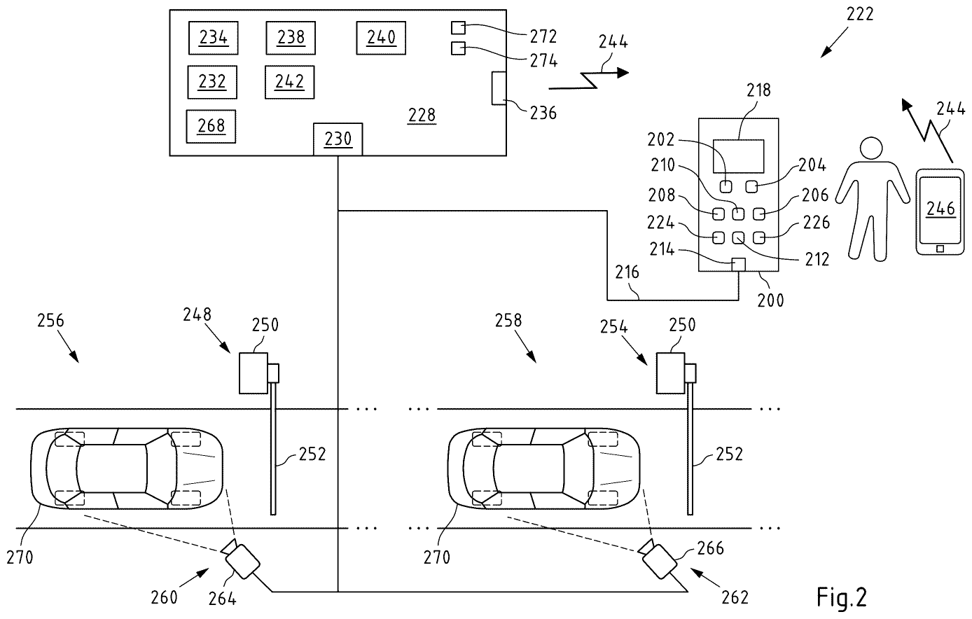

FIG. 2 shows a schematic view of an embodiment of a parking system 222 according to the invention with an embodiment of a parking machine 200 according to the invention. In order to avoid repetitions, only the differences of the embodiment shown in FIG. 1 are described below, and otherwise reference is made, in particular, to the previous explanations.

The parking system 222 comprises at least one parking machine 200 and at least one (central) data processing device 228. The shown parking machine 200 comprises at least one processor 202, a memory means 204, a user interface 208, 218, a sequence control module 206, a detection module 210, a generation module 212, and a communication module 214. The parking machine 200 is connected to the data processing device 228 by means of a first communication connection 216.

In the present embodiment, the parking machine 200 further comprises a card reader 224 and a cash payment module 226 as payment modules that may be involved in the payment process. In particular, a user can pay the parking fee for his/her parking process using the card reader 224 (and his/her payment card, such as a credit card or similar) or with cash.

Preferably, the detection module 210 can (also) be configured to monitor the (functional) state of the cash payment module 226 and, in particular, the (functional) state of the card reader 224. If the detection module 210 determines that the cash payment module 226 is not functional (e.g., the coin and/or banknote cash box is full or there is no change available in the coin and/or banknote cash box), the detection module 210 can detect an execution error of the parking machine 200. The generation module 212 can then cause an outputting of the readable communication data set.

If the detection module 210 determines that the card reader 224 is not functioning (e.g., cards cannot be read), the detection module 210 can detect an execution error of the parking machine 200. The generation module 212 can then cause an outputting of the readable communication data set.

Preferably, the detection module 210 can be (further) configured to monitor the (functional) state of the user interfaces 208, 218 of the parking machine 200. If the detection module 210 determines that at least one user interface 208, 218 is not functional, the detection module 210 can detect an execution error of the parking machine 200. The generation module 212 can then cause an outputting of the readable communication data set. The detection module 210 can, in particular, monitor the (functional) state of a parking ticket reader and/or a touch display and/or a keyboard of the machine 200.

As has been described, in preferred embodiments of the invention, the generation module 212 can only cause an outputting of the readable communication data set if it is not possible to carry out the payment process at the parking machine 200 at all, in this embodiment, for example, if both the card reader 224 and the cash payment module 226 are not functional.

The shown data processing device 228 comprises a first communication module 230 and a second communication module 236. As can be seen, the first communication module 230 is configured to communicate by means of the first communication connection 216.

The parking system 222 comprises, in particular, a parking device, which is not shown in FIG. 2 for the sake of clarity. The parking device, such as a parking lot, a parking garage, etc., serves to enable users to (temporarily) park their vehicles in parking spaces of the parking device. A corresponding process is referred to, in particular, as a parking process.

Preferably, at least one entry 256 and at least one exit 258 can be provided. A vehicle 270 can drive into the parking device via the at least one entry 256 (of the parking system 222). Furthermore, a vehicle 270 can drive out of the parking device via the at least one exit 258 (of the parking system 222).

Preferably, the parking system 222 can comprise a (restricted) vehicle access device 248 arranged at the entry 256 with a blocking means 250, 252. In the present embodiment, a barrier arm 252 movable at a base 250 between an open position and a closed position is provided as an example of blocking means 250, 252. It shall be understood that other blocking means may be provided in variants of the invention, or an vehicle access device without (physical) blocking means.

The parking system 222 may comprise a vehicle access device 254 arranged at the exit 258 and equipped with a blocking means 250, 252. It shall be understood that in variants of the invention an vehicle access device without a blocking means may also be provided.

The parking system 222 comprises, for example, at least one first license plate recognition equipment 260 configured to determine a vehicle license plate of a vehicle 270 driving into a parking device. The first license plate recognition equipment 260 comprises at least one camera 264. The camera 264 can be arranged at the entry 256. In particular, the camera 264 can be arranged at the entry 256 in such a way that the license plate of a vehicle 270 driving through the entry area (e.g., in front of the blocking element 250, 252) passes through the detection area of the camera 264, in particular, must always pass through it.

The first license plate recognition equipment 260 may further comprise at least one image evaluation module 232. For example, the image evaluation module 232 may be implemented as a software module executable by the processor 272 and the memory means 274 in the data processing device 228. By means of a (wireless and/or wired) data communication network, detected image data can be transmitted from the camera 264 to, for example, the first communication module 230 (or a further communication module) of the data processing device 228 and, in particular, provided to the image evaluation module 232.

The first license plate recognition equipment 260 may, in particular, be an LPR license plate recognition equipment. In an LPR license plate recognition equipment, the image of the vehicle license plate detected by the camera 264 is evaluated by the image evaluation module 232, in particular, by means of OCR (optical character recognition) in order to determine the vehicle license plate number.

It shall be understood that, in particular, in the case of an entry with a plurality of lanes, a corresponding plurality of cameras may be provided.

The parking system 222 comprises, for example, at least one second license plate recognition equipment 262, which is configured to identify a vehicle license plate of a vehicle 270 driving out of the parking device. The second license plate recognition equipment 262 comprises at least one camera 266. The camera 266 can be arranged at the exit 258. In particular, the camera 266 can be arranged at the exit 258 in such a way that the license plate of a vehicle 270 driving out of an exit area passes through the detection area of the camera 266, in particular, must always pass through it.

The second license plate recognition equipment 262 may further comprise at least one image evaluation module 232. In particular, the first license plate recognition equipment 260 and second license plate recognition equipment 262 may share a common image evaluation module 232.

By means of the data communication network, image data detected by the camera 266 can be transmitted to the communication module 230 of the data processing device 228 and, in particular, provided to the image evaluation module 232. The second license plate recognition equipment 262 can, in particular, be an LPR license plate recognition equipment, like the first license plate recognition equipment.

In variants of the invention, the parking system may alternatively or additionally comprise a parking ticket dispensing module at an entry and a validation device at the exit. The parking ticket dispensing module may be configured to dispense a parking ticket containing a parking ticket identifier as a parking transaction identifier. The validation device can be configured to read a parking ticket identifier from a parking ticket and to release the vehicle access device if the parking ticket identifier is marked as authorized for exit. For this purpose, the validation device can communicate with the data processing device.

In particular, the storage module 234 of the data processing device 228 can be configured to receive entry data sets. An entry data set can contain at least the parking transaction identifier (e.g., in the form of the (determined) vehicle license plate number and/or in the form of the parking ticket identifier of the dispensed parking ticket) and an entry time point (e.g., the time point at which the vehicle license plate number was detected or the time point at which the parking ticket was dispensed). For example, the parking ticket dispensing module and/or a license plate recognition equipment can provide a respective entry data set to the storage module 234.

The at least one storage module 234 can be configured to store the respective received entry data set in a database 268 of the parking system 222. The database 268 can, for example, be implemented in the data processing device 228.

The data processing device 228 preferably comprises at least one parking duration determination module 238. The parking duration determination module 238 can be configured to determine the parking duration of a parking process based on the parking end time point of a terminal device data set received via the second communication module 236 and an entry time point of a stored entry data set. The entry data set from the plurality of stored entry data sets can be assigned to the terminal device data set on the basis of the respective parking transaction identifier.

In particular, a mobile terminal 246 of a user can transmit a terminal device data set by means of a second communication connection 244 that can be established based on a communication data set output by the parking machine 200 and the parking transaction identifier of the parking process of the user. As has been described, if an execution error of the parking machine 200 is detected, a graphical code can be displayed on the user interface 218, which contains at least one instruction datum as data content. The mobile terminal 246 can, for example, by means of a (not shown) camera, detect the graphical code and extract the data content in the form of the at least one instruction datum.

The at least one instruction datum (e.g., executable code that initiates the start of a browser, and a web address) serves, in particular, to establish a data connection by means of the second communication connection 244 with the data processing device 228. After the data connection has been established (in particular, after the website of the web address has been called up), the terminal device data set containing at least the parking transaction identifier can be transmitted. The transmitting can be carried out, in particular, by the user by entering or scanning the parking transaction identifier using his/her mobile terminal device 246. The end time point of the parking process, which is used to determine the parking duration, can be, for example, the time of receipt of the terminal device data set.

Based on the parking transaction identifier of the terminal device data set, the corresponding entry data set with the identical parking transaction identifier can be determined from the plurality of stored entry data sets. The parking duration can then be determined based on the parking end time point and the entry time point.

In a similar way, the parking duration determination module 238 can determine the parking duration of a parking process based on a received parking data set and the associated entry data set.

In addition, the data processing device 228 may comprise at least one parking fee determination module 240, which is configured to determine the parking fee for a parking process based on the determined parking duration of the parking process and at least one tariff date (in a known manner). The second communication module 236 may be configured to transmit the determined parking fee to the mobile terminal 246, in particular, via the second communication connection 244.

A payment module 242 of the data processing device can then enable a paying of the determined parking fee by the mobile terminal 246.

If (successful) payment of the parking fee is detected, the associated parking transaction identifier can be marked as authorized for exit, for example, by the processor 272. If this parking transaction identifier is then detected by the second license plate recognition equipment or the validation device, a driving out can be authorized and the barrier arm 252 can be opened.

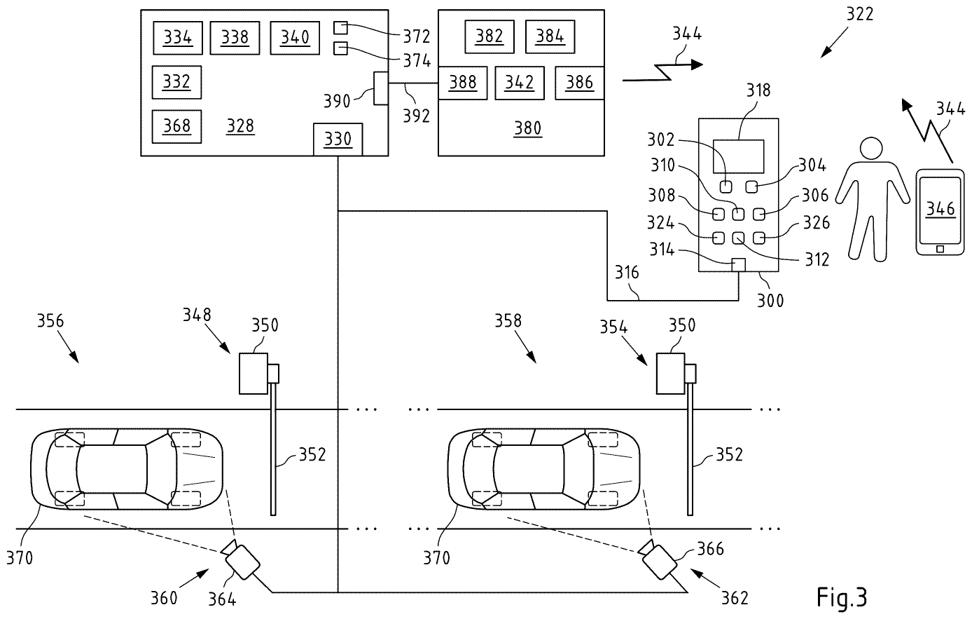

FIG. 3 shows a schematic view of a further embodiment of a parking system 322 according to the invention with an embodiment of a parking machine 300 according to the invention. In order to avoid repetitions, only the differences to the embodiments according to FIGS. 1 and 2 are described below, with reference being made, in particular, to the previous explanations.

In comparison to FIG. 2, the parking system 322 according to FIG. 3 comprises, in particular, a computing device 380 which is connected to the data processing device 328 by means of a third communication connection 392. The computing device 380 comprises at least one processor 382 and a memory means 384 for executing and/or controlling modules 342, 386, 388 of the computing device 380.

As can be seen, in the present case, the payment module 342 is not comprised in the data processing device 328, but rather in the computing device 380. The computing device 380 may comprise a third communication module 386, which is configured to receive a terminal device data set (described above). This can be transmitted by a further communication module 388 of the computing device 380 and a further communication module 390 of the data processing device 328. The determined parking fee can be transmitted to the mobile terminal 346 by means of the computing device 380. The payment module 342 of the computing device can then enable payment of the determined parking fee by the mobile terminal 346. A (successful) payment can be reported to the data processing device 328. The associated parking transaction identifier can then be marked as authorized for exit, for example, by the processor 372, as described above.

In variants of the invention, the computing device may alternatively or additionally comprise a parking duration determination module and/or a parking fee determination module.

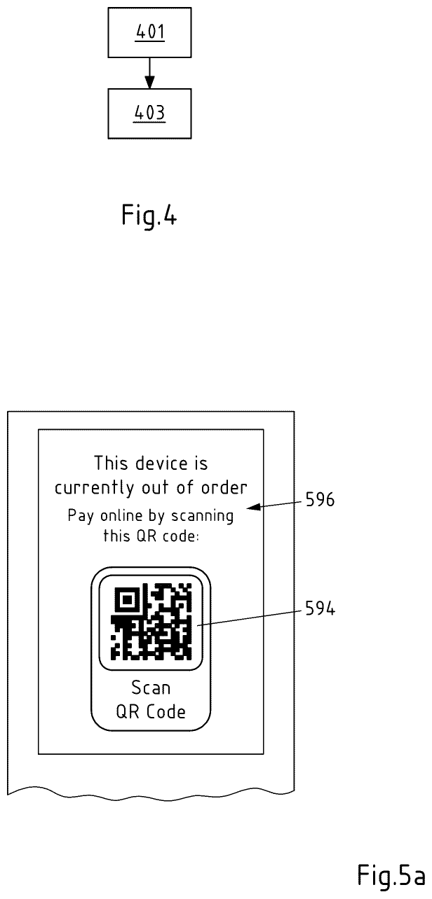

FIG. 4 shows a schematic view of an embodiment of a method according to the present invention. The method is, in particular, a computer-implemented method for operating a parking machine, in particular, a parking machine according to FIGS. 1, 2, and/or 3.

In step 401, a detecting is performed, by at least one detection module of the parking machine, of an execution error of the parking machine during the executing of parking payment requests, in particular, as has already been described.

In step 403, a causing is performed, by at least one generation module of the parking machine, of an outputting of a communication data set readable by a mobile terminal as soon as an execution error of the parking machine is detected during executing of the parking payment request, in particular, as has already been described.

The readable communication data set contains at least one instruction datum for the mobile terminal for executing a payment transaction with a data processing device and/or a computing device connectable to the data processing device independently of the parking machine.

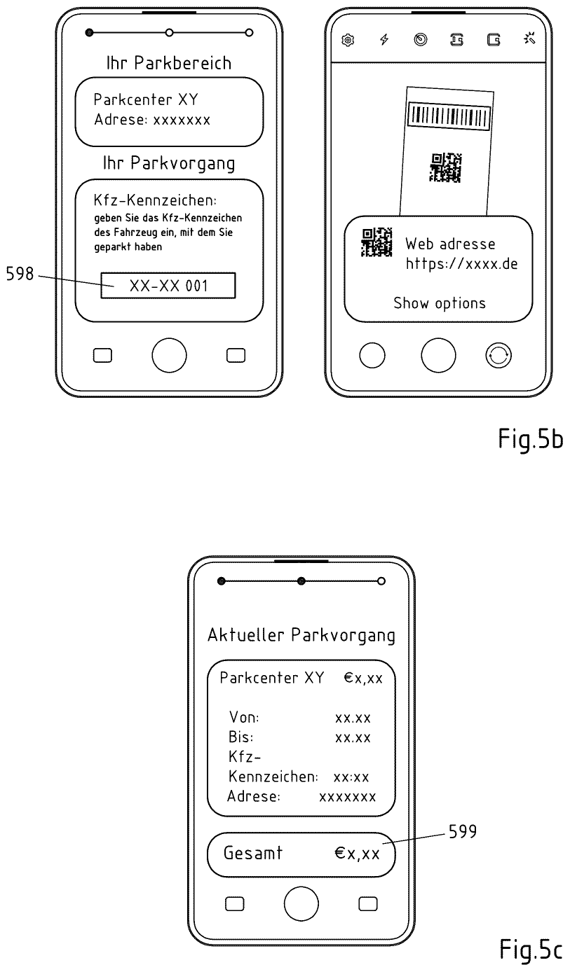

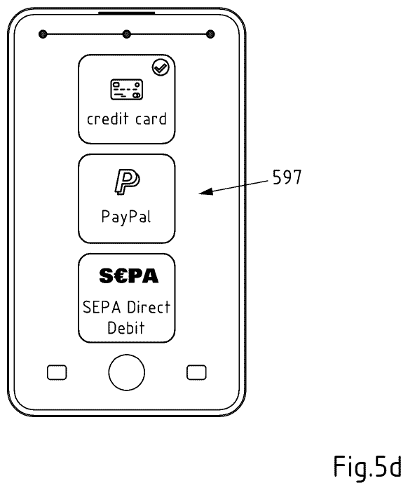

FIGS. 5a to 5d show different display screens (of a mobile terminal respectively the parking machine) at different stages of an embodiment of a method according to the invention. In order to avoid repetitions, reference is also made here to the previous embodiments. In particular, an exemplary sequence of a method according to the invention in a parking system according to the invention is explained in more detail below with reference to FIGS. 5a to 5d.

As soon as the detection module of a parking machine detects that the parking machine has an execution error, for example, it is in an “out of service” state, the generation module causes an outputting of a communication data set. As shown in FIG. 5a, by way of example, the displaying of a QR code 594 can be caused. Optionally, a prompt 596 respectively a user notice can be displayed on the parking machine display. The user notice may include instructions for the user on how to continue paying for his/her parking process using a (network-enabled) mobile terminal.

In particular, the user is instructed to scan the QR code 594 displayed on the display with a network-enabled mobile terminal (e.g., smartphone). The QR code 594 contains, in particular, a web address (URL) as an instruction datum, which leads to an alternative payment method independent of the (defective) parking machine.

The user can scan the QR code 594 with his/her mobile terminal and, based on the at least one instruction datum, is (automatically) redirected in a browser on the mobile terminal to a payment platform that can be provided, for example, by the data processing device or the computing device.

In the payment platform, the user can enter the parking transaction identifier (see reference number 598) for the parking process to be paid (e.g., the license plate number of the parked vehicle or an optical code of a parking ticket), as shown in FIG. 5b. The optical code can be entered by scanning the optical code of the parking ticket, as also shown in FIG. 5b.

The parking duration and parking fee (see reference number 599) can then be determined in the manner described above. The parking fee to be paid can be transferred to the mobile terminal and displayed by the mobile terminal, as shown in FIG. 5c.

The user can pay his/her parking fees cashlessly by entering a payment method (see reference number 597), e.g., credit card, PayPal, or SEPA direct debit, as shown in FIG. 5d.

### LIST OF REFERENCE SIGNS

100 parking machine
102 processor
104 memory means
106 sequence control module
108 user interface
110 detection module
112 generation module
114 communication module
116 first communication connection
118 user interface
120 near field interface
200 parking machine
202 processor
204 memory means
206 sequence control module
208 user interface
210 detection module
212 generation module
214 communication module
216 first communication connection
218 user interface
222 parking system
224 card reader
226 cash payment module
228 data processing device
230 communication module
232 image evaluation module
234 storage module
236 communication module
238 parking duration determination module
240 parking fee determination module
242 payment module
244 communication connection
246 mobile terminal
248 vehicle access device
250 blocking element
252 blocking element
254 vehicle access device
256 entry
258 exit
260 license plate recognition equipment
262 license plate recognition equipment
264 camera
266 camera
268 database
270 vehicle
272 processor
274 memory means
300 parking machine
302 processor
304 memory means
306 sequence control module
308 user interface
310 detection module
312 generation module
314 communication module
316 first communication connection
318 user interface
322 parking system
324 card reader
326 cash payment module
328 data processing device
330 communication module
332 image evaluation module
334 storage module
336 communication module
338 parking duration determination module
340 parking fee determination module
342 payment module
344 communication connection
346 mobile terminal
348 vehicle access device
350 blocking element
352 blocking element
354 vehicle access device
356 entry
358 exit
360 license plate recognition equipment
362 license plate recognition equipment
364 camera
366 camera
368 database
370 vehicle
372 processor
374 memory meany
380 computing device
382 processor
384 memory means
386 communication module
388 communication module
390 communication module
392 communication connection
401 step
403 step
594 QR code
596 request
597 means of payment
598 field for parking transaction ID
599 parking fee

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A parking machine for a parking system, comprising:
at least one user interface configured to receive a parking payment request containing a parking data set with at least one parking transaction identifier,
at least one sequence control module configured to control a payment process based on the received parking payment request,
wherein the payment process comprises at least a transmitting of the parking data set to a data processing device connected remotely to the parking machine by means of a first communication connection,
the parking machine comprises:
at least one detection module configured to detect an execution error of the parking machine during executing of the parking payment request, and
at least one generation module configured at least to cause an outputting of a communication data set readable by a mobile terminal if an execution error of the parking machine is detected during the executing of the parking payment request,
wherein the readable communication data set comprises at least one instruction datum for the mobile terminal for executing the payment process with the data processing device and/or with a computing device connectable to the data processing device independently of the parking machine.

2. The parking machine according to claim 1, wherein
the generation module is configured to generate a graphical code containing the at least one instruction datum, and
the generation module is configured to cause an outputting of the graphical code by causing a displaying of the graphical code on an optical display of the parking machine.

3. The parking machine according to claim 1, wherein
the generation module is configured to generate a transmission code transmittable by means of a near-field interface of the parking machine containing the at least one instruction datum, and
the generation module is configured to cause an outputting of the communication data set by causing a transmitting of the transmission code by means of the near-field interface.

4. The parking machine according to claim 2, wherein
the generation module is configured to generate a dynamic graphical code and/or a dynamic transmission code.

5. The parking machine according to claim 1, wherein
the detection module is configured to monitor the first communication connection, and
the detection module is configured to detect an execution error of the parking machine if, by the monitoring of the first communication connection a communication interruption with the data processing device is detected.

6. The parking machine according to claim 5, wherein
the detection module is configured to monitor the first communication connection by monitoring data log data and/or operating data received by the parking machine from the data processing device via the first communication connection, and
the detection module is configured to detect a communication interruption if no reception of the data log data and/or the operating data is detected for a predefined period of time.

7. The parking machine according to claim 1, wherein
the detection module is configured to monitor at least one payment module of the parking machine involved in the payment process, and
the detection module is configured to detect an execution error of the parking machine if, by the monitoring of the at least one payment module, it is determined that the payment process at the parking machine cannot be executed.

8. The parking machine according to claim 7, wherein
the at least one payment module is a cash payment module,
wherein the detection module is configured to monitor the state of the cash payment module,
the at least one payment module is a card reader,
wherein the detection module is configured to monitor the state of the card reader.

9. The parking machine according to claim 1, wherein
the detection module is configured to monitor at least one user interface of the parking machine, and
the detection module is configured to detect an execution error of the parking machine if, by the monitoring of the at least one user interface, it is detected that a payment process at the parking machine cannot be executed.

10. The parking machine according to claim 9, wherein
the at least one user interface is a parking ticket reader,
wherein the detection module is configured to monitor the state of the parking ticket reader,
the at least one user interface is a touch display,
wherein the detection module is configured to monitor the state of the touch display.
the at least one user interface is a keyboard,
wherein the detection module is configured to monitor the state of the keyboard.

11. The parking machine according to claim 1, wherein
the communication data set comprises as an instruction datum at least one network address of the data processing device and/or one network address of the computing device such that a data connection is establishable between the mobile terminal and the data processing device and/or the computing device by means of a second communication connection,
wherein the second communication connection differs from the first communication connection.

12. A parking system, comprising:
at least one parking machine according to claim 1, and
a data processing device connected to the parking machine by means of a first communication connection and/or at least one computing device connectable to the data processing device.

13. The parking system according to claim 12, wherein
the data processing device is configured to receive an entry data set containing at least one parking transaction identifier and an entry time point of a vehicle,
the data processing device comprises at least one storage module configured to store the received entry data set in a database of the parking system,
the data processing device comprises, in particular, at least one first communication module configured to receive the parking data set.

14. The parking system according to claim 12, wherein
the data processing device comprises at least one second communication module configured to receive a terminal device data set from a mobile terminal device containing at least a parking transaction identifier,
the computing device comprises at least one third communication module configured to receive a terminal device data set from a mobile terminal device containing at least a parking transaction identifier.

15. The parking system according to claim 13, wherein
the data processing device comprises at least one parking duration determination module configured to determine the parking duration of a parking process based on a parking end time point of a terminal device data set and an entry time point of a stored entry data set, wherein the entry data set is assignable to the terminal device data set from the plurality of stored entry data sets on the basis of the respective parking transaction identifier.

16. The parking system according to claim 15, wherein
the data processing device comprises at least one parking fee determination module configured to determine the parking fee for a parking process based on the determined parking duration of the parking process and at least one tariff date,
wherein the second communication module is configured to transmit the determined parking fee to the mobile terminal.

17. A computer-implemented method for operating a parking machine, comprising:
detecting, by at least one detection module of the parking machine, an execution error of the parking machine during executing parking payment requests, and
causing, by at least one generation module of the parking machine, an outputting of a communication data set readable by a mobile terminal if an execution error of the parking machine is detected during the executing of the parking payment request,
wherein the readable communication data set contains at least one instruction datum for the mobile terminal for executing a payment process with a data processing device and/or with a computing device connectable to the data processing device independently of the parking machine.

18. A computer program comprising commands which, when executed by at least one processor of a parking machine, cause the parking machine to execute and/or control the method according to claim 17.

19. The parking system according to claim 13, wherein
the data processing device comprises, at least one first communication module configured to receive the parking data set.

20. The method according to claim 17, wherein
the parking machine comprises:
at least one user interface configured to receive a parking payment request containing a parking data set with at least one parking transaction identifier,
at least one sequence control module configured to control a payment process based on the received parking payment request,
wherein the payment process comprises at least a transmitting of the parking data set to a data processing device connected remotely to the parking machine by means of a first communication connection,
the parking machine comprises:
at least one detection module configured to detect an execution error of the parking machine during executing of the parking payment request, and
at least one generation module configured at least to cause an outputting of a communication data set readable by a mobile terminal if an execution error of the parking machine is detected during the executing of the parking payment request,
wherein the readable communication data set comprises at least one instruction datum for the mobile terminal for executing the payment process with the data processing device and/or with a computing device connectable to the data processing device independently of the parking machine.
